(19) United States
(12) Patent Application Publication
(10) Pub. No.: US 2021/0380334 A1
(43) Pub. Date: Dec. 9, 2021

(54) CAPSULE FOR BEVERAGE PREPARATION WITH INTEGRALLY FORMED SEALING MEMBER

(71) Applicant: SOCIETE DES PRODUITS NESTLE S.A., Vevey (CH)

(72) Inventors: Veith Behrmann, Villeneuve (CH); Martin Guillermo Mueller, Lausanne (CH); Guido Bambagioni, Perugia (IT)

(21) Appl. No.: 17/283,867

(22) PCT Filed: Oct. 9, 2019
(86) PCT No.: PCT/EP2019/077287

§ 371 Date: Apr. 8, 2021

(30) Foreign Application Priority Data
Oct. 10, 2018 (EP) 18199544.0

(51) Int. Cl. B65D 85/804; A47J 31/40; A47J 31/34

(52) U.S. Cl. CPC B65D 85/8064; A47J 31/34; A47J 31/407

(57) ABSTRACT

The invention relates to a capsule (10) designed for preparing a beverage upon injection of liquid into the capsule by means of a beverage preparation machine. The capsule (10) comprises a cup-shaped base body (1) for holding beverage preparation ingredients and a flange-like rim (2) with a sealing member (3) comprising an inner and an outer series (4,5) of arc-shaped protrusions (4a,5a), wherein the base-body (1), the flange-like rim (2) and the sealing member (3) are made integrally from metallic material such as aluminum, in which the inner and outer series (4,5) of the sealing member (3) are concentrically arranged on a surface (2a) of the flange-like rim (2) such as to form an annular space (6) there-between for receiving a sealing surface (21a) of a capsule engagement member (21) of the beverage preparation machine (20). The respective arc-shaped protrusions (4a,5a) of the inner and outer series (4,5) are continuous protrusions with circumferentially extending gaps (4b,5b) formed there-between, wherein the respective arc-shaped protrusions (4a,5a) of the inner and outer series (4,5) are arranged such as to circumferentially overlap outside the circumferentially extending gaps (4b, 5b) of the inner and outer series (4, 5) in side view of the capsule, and wherein the arc-shaped protrusions (4a,5a) of the inner and outer series (4,5) are locally connected together by at least one bridging element (8) positioned proximate to each circumferentially extending gaps (4b, 5b) of the inner and outer series (4, 5).

### FIELD OF THE INVENTION

The present invention relates to a capsule designed for preparation of a food product such as a beverage with enhanced sealing means. In particular, the invention relates to a capsule having a body with an integrally formed sealing member made from metallic material such as aluminum.

### BACKGROUND AND OBJECT OF THE INVENTION

Capsules for preparation of a food product such as a beverage are widely known in the market. An example of such capsule that is intended for being used with a beverage preparation machine is described in EP 0 512 468 A1. For beverage preparation in a dedicated beverage preparation machine, the capsule is inserted to the machine and ingredients contained in the capsule are made to interact with liquid provided to the capsule in order to form a desired beverage that is then made to leave the capsule. Thereby, the capsule is opened under the effect of rising pressure within the capsule, which urges an outlet face of the membrane against opening means such as raised elements provided on a supporting part of the beverage preparation machine. Sealing of the capsule during the beverage preparation process is obtained by an outer portion of a flange-like rim of the capsule, which is contacted along a circumferential contact line by a suitably shaped engagement member of the beverage preparation machine.

In order to enhance sealing between the capsule and an engagement member of the beverage preparation machine, capsules have been developed in which a dedicated sealing member is applied and wherein the sealing member is of different material than the capsule body. EP 1 654 966 A1, EP 1 849 715 A1 and EP 2 151 313 A1 for example relate to such a capsule in which a sealing member of rubber elastic material is applied to the capsule. The sealing member may be applied onto the capsule body by means of liquid depositing and hardening, gluing or by crimping a portion of the capsule body and/or the flange-like rim of the capsule onto the sealing member.

A disadvantage of these capsules is a more complex manufacturing process in which the capsule and the sealing member are manufactured in individual manufacturing steps and then assembled. The solution is also costly to produce both in terms of material cost and production cost. Therefore, a solution is sought-after which enables a facilitated manufacturing process while at the same time providing enhanced sealing properties of the flange-like rim of the capsule.

Capsules are also known, which comprise an integrally formed sealing member, i.e. a sealing member made from the same material as the capsule body respectively the flange-like rim of the capsule. EP 2 303 077 B1, EP 2 387 922 B1 and EP 2 814 328 B1, for example, relate to a capsule comprising a sealing member formed of a plurality of concentric annular protrusions integrally formed with the flange-like rim.

WO 2014/012783 A1, WO 2014/184652 A1, WO 2016/186489 A1, WO 2016/186495 A1 and WO 2016/186496 A1 also disclose capsules for beverage preparation and which comprise a flange-like rim portion with an integrally formed annular sealing member.

In particular, WO 2016/207845 A1 relates to a plastic capsule comprising a flange-like rim with a single annular sealing ring that is enclosed by inner and outer centering projections, in which the centering projections comprise a multitude of arc-shaped elements separated circumferentially by gaps, which are designed to provide a better centering of the sealing ring with respect to a circumferential sealing edge of a beverage preparation machine.

These known capsules however suffer the disadvantage that due the manufacturing tolerances in the dimensions of the capsules and in those of the enclosing member of the beverage preparation machine, the two parts are not properly matching and engaging, thus reducing the tightness between capsule and engagement member with risk of leaks and beverage dilution with water.

Furthermore, due to the circumferentially arranged projections of the flange-like rim, tensions may occur during forming of the projections in the manufacturing process, which in turn lead to defects in the sealing member and/or the flange-like rim and which negatively affect the sealing properties of the sealing member.

This particularly applies for metal capsules, e.g. made from aluminum or aluminum alloy. Thereby, defects such as stress cracking, wrinkling and other surface defects may occur during the deep drawing process of aluminum when forming the capsule.

In addition, the circumferentially arranged sealing protrusions may lead to a less tolerant sealing adjustment with concentricity problems.

It is therefore an object of the present invention to provide an improved capsule which overcomes the disadvantages of the prior art solutions. This object is solved by the independent claims. The dependent claims define further preferred embodiments of the invention.

### SUMMARY OF THE INVENTION

The invention relates to a capsule designed for preparing a beverage upon injection of liquid into the capsule by means of a beverage preparation machine, in which the capsule comprises a cup-shaped base body for holding beverage preparation ingredients and a flange-like rim with a sealing member comprising an inner and an outer series of arc-shaped protrusions, and in which the base-body, the flange-like rim and the sealing member are made integrally from metallic material such as aluminum.

According to the invention, the inner and outer series of the sealing member are concentrically arranged on a surface of the flange-like rim such as to form an annular space there-between for receiving a sealing surface of a capsule engagement member of the beverage preparation machine, wherein the respective arc-shaped protrusions of the inner and outer series are continuous protrusions with circumferentially extending gaps formed there-between, wherein the respective arc-shaped protrusions of the inner and outer series are arranged such as to circumferentially overlap outside the circumferentially extending gaps of the inner and outer series in side view of the capsule, and wherein the arc-shaped protrusions of the inner and outer series are locally connected together by at least one bridging element positioned proximate to each circumferentially extending gaps of the inner and outer series.

Hence, according to a proposed embodiment, the bridging elements are located between the arc-shaped protrusions of the inner and outer series and are locally connecting them. They are positioned transversally between the arc-shaped protrusions of the inner and outer series and are thereby closing the annular space between the inner and outer series of arc-shaped protrusions.

In a preferred embodiment, the at least one bridge element is integral with the arc-shaped protrusions of the inner and outer series.

The capsule according to the invention enables a reliable and tolerant sealing structure made from a single integral piece and thus by omitting any additional material such as rubber. The capsule may thus be formed in a facilitated manufacturing process at reduced costs, while at the same time providing an enhanced sealing member without any material defects such as cracks, wrinkling and surface defects that could affect the capsule quality and tightness and as well the extraction process.

The combination of the interaction between engagement member and the inner and outer series of arc-shaped protrusions, and of the engagement between the engagement member and bridging elements, by compression of the bridging elements 8, generates the required tightness between the capsule and the enclosing member of the coffee machine needed for coffee extraction.

The term “overlap” in the sense of the present application relates to the respective arc-shaped protrusions of the inner and outer series of protrusions being arranged such that the respective protrusions are at least partially covering each other in side view (see direction SV in FIG. 5a for example). In particular, when seen in side view, the respective arc-shaped protrusions of the outer series of protrusions at least partially overlap respectively cover the respective arc-shaped protrusion arranged of the inner series of protrusions such as to cover any gaps formed between the arc-shaped protrusions of the inner series. In top view onto the flange-like rim, the respective arc-shaped protrusions are overlapping at least partially in radial direction.

The flange-like rim is preferably an essentially planar collar that extends from an open end of the cup-shaped base body essentially perpendicular to outer lateral side walls of the base body and/or to a rotational axis of the capsule. The inner and outer series of arc-shaped protrusions are arranged distant from the cup-shaped base body and from the outer periphery of the flange-like rim.

The respective protrusions and bridging elements of the sealing member are preferably integrally formed in the otherwise essentially planar flange-like rim. The protrusions formed in the flange-like rim preferably comprise a material thickness essentially corresponding to the rest of the flange-like rim.

The protrusions and bridging elements in the flange-like rim are preferably made by a deep-drawing process. In a preferred embodiment, the capsule body, the flange-like rim and the sealing member are manufactured in a single deep-drawing process. The capsule may e.g. be produced by deep-drawing an initially flat metal sheet.

The capsule is preferably made from a single sheet of metal such as aluminum.

The respective arc-shaped protrusions of the inner and outer series of the sealing member as well as the bridging elements are arranged on the same surface of the flange-like rim. The surface is directed towards the cup-shaped base body of the capsule. On a surface of the flange-like rim opposite thereto, a closing membrane may be connected to the capsule base body.

The respective arc-shaped protrusions of the inner and outer series of the sealing member are preferably continuous protrusions with gaps formed between the respective protrusions of each series. The gaps are thus annular gaps which extend between respective adjacent arc-shaped protrusions of the inner and outer series.

The inner and outer series of the arc-shaped protrusions preferably each comprise at least two, preferably at least three or four arc-shaped protrusions. The inner and outer series may as well each comprise a multitude of arc-shaped protrusions.

The bridging elements extend transversally between the arc-shaped protrusions of the inner and outer series and close the annular space between the inner and outer series of arc-shaped protrusions.

The overlap between the respective arc-shaped protrusions of the inner and outer series of protrusions preferably equals at least 10%, preferably at least 20% but less than 50% of an arc length L of the respective overlapping protrusions. Thereby, the arc length L refers to the minimum arc length of the respective overlapping arc-shaped protrusions of the inner and outer series of protrusions. The arc length of each protrusion along the circumference of the flange-like rim depends on the total number of protrusions for both the inner and outer series of protrusions. The higher the number, the shorter the respective arc length.

The overlap angular length between the respective arc-shaped protrusions is between 5° and 85°, preferably between 10° and 70°, most preferably between 20° and 60°.

In a preferred embodiment, the respective arc-shaped protrusions of the inner and outer series are radially arranged equidistant to each other about the circumference of the base-body such as to form constant circumferentially extending gaps between the respective protrusions.

The annular space between the inner and outer series of arc-shaped protrusions is designed for receiving a preferably annular sealing surface of a capsule engagement member of the beverage preparation machine. The engagement member is preferably an essentially bell-shaped engagement member respectively a so-called capsule cage designed to house the cup-shaped base body of the capsule. The sealing surface of the engagement member may be a flat or rounded end surface of the engagement member.

In a preferred mode, the sealing surface of the engagement member is arranged for engaging the protrusions of the inner series of arc-shaped protrusions and the protrusions of the outer series of arc-shaped protrusions. The engagement of the sealing surface of the engagement member may be such that it may deform at least partially the protrusions. The engagement of the sealing surface of the engagement member may be such that it provides at least substantially radially oriented sealing forces with the protrusions.

The annular space between the inner and outer series of arc-shaped protrusions is preferably void of any protrusion. A bottom portion of the annular space is preferably a flat annular portion. The bottom portion of the annular space preferably corresponds to an upper surface of the flange-like rim portion.

The inner and outer series of arc-shaped protrusions are arranged at a radial distance d of between 0.6 to 1.2 mm, more preferably between 0.8 and 1.0 mm for forming the annular space there-between. The radial distance d thus relates to a thickness of the annular space for receiving the sealing surface of the capsule engagement member. The distance d between the respective arc-shaped protrusions is preferably chosen such as to be equal to or less than a radial width D of the annular sealing surface.

In a preferred embodiment, the radial distance d is chosen to be at least 1-2%, preferably at least 2-5% less than the radial width of the annular sealing surface of the engagement member of the beverage preparation machine.

In a preferred embodiment, the respective protrusions of the inner and outer series comprise essentially the same dimensions in sectional side view. The respective protrusions of the inner and outer series may comprise the same height and/or width.

However, the respective protrusions may be of different height and/or width. For example, the protrusions of the outer series may be of smaller height than the protrusions of the inner series or vice versa. For example, the protrusions of the outer series may be of smaller width than the protrusions of the inner series or vice versa.

The protrusions in each inner or outer series may be of different height and/or width.

The respective protrusions of the inner and outer series preferably comprise a base width BW of between 0.3 and 1.3 mm, more preferably between 0.5 and 1.0 mm and/or a height H of between 0.8 and 1.7 mm, more preferably between 1 and 1.5 mm.

The respective protrusions preferably comprise in sectional side view a lower base portion B with two opposing preferably linear wall sections and an upper portion A with two opposing preferably rounded wall sections.

The two opposing rounded wall sections of the upper portion A are preferably joined by a rounded tip portion C.

The two opposing linear wall sections are preferably arranged to converge towards the upper portion A of the respective protrusions. The two opposing linear wall sections are preferably arranged at an angle of inclination of between 3 to 12°, more preferably of between 5 to 10° with respect to the normal of the flange-like rim and/or with respect to a rotational axis of the capsule.

The two opposing rounded wall sections of the upper portion A preferably comprise a radius R1 of between 0.5 to 5.5, more preferably between 1 and 5 mm.

The rounded tip portion C preferably comprise a radius R2 of between 0.2 and 2.3 mm, more preferably between 0.5 and 2 mm.

The two opposing wall sections of the lower portion B may be not strictly linear but slightly convex. For example, the two opposing wall sections A and B may form together continuously convex wall sections of increasing curvature in direction to the tip portion C.

The capsule preferably further comprises a closing membrane connected to the base body and/or the flange-like rim of the capsule. The closing membrane is preferably connected to a surface of the flange-like rim opposite to the surface at which the inner and outer series of arc-shaped protrusions are arranged. The closing membrane may be connected to the flange-like rim by means of an adhesive and/or welding technique. The closing membrane is preferably a closed membrane, i.e. void of any perforations. The closing membrane may however as well comprise pre-formed perforations therein. The closing membrane is preferably an aluminum foil. The foil is preferably sealed to the flange-like rim such as to form a seal hermetical to gas with the capsule base body for preserving freshness of the ingredients contained in the cartridge.

In a further aspect, the invention relates to a system comprising a capsule as described above and a beverage preparation machine designed to provide heated and/or pressurized liquid into the capsule for preparing a beverage upon interaction of the liquid with ingredients held within the capsule.

The beverage preparation machine preferably comprises a pump, heating and/or cooling means, a liquid supply such as a water tank and/or a beverage brewing chamber for selectively receiving a capsule in order to prepare a beverage therefrom.

The beverage preparation machine preferably comprises a capsule engagement member, e.g. as part of the brewing chamber, which is designed to house a capsule and in particular the capsule base body when the capsule is provided into the machine. The engagement member comprises an annular sealing surface designed to interact with the sealing member of the capsule in order to enable an effective sealing of the capsule during the beverage preparation process. As mentioned earlier, the sealing surface of the engagement member may be arranged for engaging the protrusions of the inner series of arc-shaped protrusions and the protrusions of the outer series of arc-shaped protrusions. The engagement of the sealing surface of the engagement member may be such that it may deform at least partially the protrusions. The engagement of the sealing surface of the engagement member may be such that it provides at least substantially radially oriented sealing forces with the protrusions.

The presence of the bridging elements, by closing the space between the inner and outer series of protrusion, further improve the tightness performances generated by the interaction of the arc-shaped protrusion with the sealing surface of the engagement member.

The beverage preparation machine preferably further comprises perforation means such as injection blades or the like, which are designed to perforate an inlet face of the capsule, in particular situated at a closed end of the capsule base body, and to inject liquid into the capsule interior.

The beverage preparation machine preferably further comprises a capsule support designed to hold the flange-like rim of the capsule at a side opposite to a side at which the engagement member of the machine engages the sealing member of the capsule. The capsule support preferably comprises opening means such as e.g. truncated pyramid-like elements against which a closing membrane of the capsule may be urged during pressure rise within the capsule such as to open the closing member e.g. by tearing or rupturing.

The capsule according to the present invention is preferably rotational symmetric, i.e. symmetric along its vertical axis.

The thickness t of the base body of the capsule preferably lies between 0.3 and 1.7 mm, more preferably between 0.7 and 1.3 mm. The thickness t1 of the closing membrane preferably lies between 60 and 100 microns (including the embossed structure and lacquer(s) on surface).

The beverage preparation ingredients provided in the capsule are preferably chosen from the group consisting of roasted ground coffee, tea, instant coffee, a mixture of roasted ground coffee and instant coffee, a syrup concentrate, a fruit extract concentrate, a chocolate product, a milk-based product or any other dehydrated edible substance, such as dehydrated stock. The liquid to be used for beverage preparation is preferably water of any temperature.

The invention further relates to a cup-shaped base body of a capsule for preparation of a food product with an enhanced integrally formed sealing member comprising inner and outer series of arc-shaped protrusions connected together with bridging elements.

### BRIEF DESCRIPTION OF THE FIGURES

Further features, advantages and objects of the present invention will become apparent for a skilled person when reading the following detailed description of embodiments of the present invention, when taken in conjunction with the figures of the enclosed drawings.

These drawings depict only some embodiments in accordance with the disclosure and are, therefore, not to be considered limiting of its scope, the disclosure will be described with additional specificity and detail through use of the accompanying drawings. Hence, it will be appreciated that the invention as claimed is not intended to be limited in any way by these examples.

FIG. 1a is a perspective side view of a preferred embodiment of a capsule according to the invention presenting a bridging element in between the arc shaped protrusions.

FIG. 1b is a detail of a bridging element that could be used in a capsule according to FIG. 1a.

FIG. 1c is a detail of a bridging element that could be used in a capsule according to FIG. 1a.

FIG. 2 is a top view of the capsule according to FIG. 1a.

FIG. 3 is a schematic top view onto a preferred embodiment of a capsule according to the invention.

FIG. 4 is a cross sectional side view of a protrusion of the sealing member according to the invention.

FIG. 5a is a sectional side view in direction B-B of FIG. 2 of a preferred embodiment of the sealing member according to the invention and an engagement member of a beverage preparation machine before engaging with each other.

FIG. 5b is a sectional side view in direction B-B of FIG. 2 of a preferred embodiment of the sealing member according to the invention and an engagement member of a beverage preparation machine after engaging with each other.

FIG. 6a is a sectional side view in direction A-A of FIG. 2 of a preferred embodiment of the sealing member according to the invention and an engagement member of a beverage preparation machine before engaging with each other.

FIG. 6b is a sectional side view in direction A-A of FIG. 2 of a preferred embodiment of the sealing member according to the invention and an engagement member of a beverage preparation machine after engaging with each other.

FIG. 7a is a sectional side view in direction D-D of FIG. 2 of a preferred embodiment of the sealing member according to the invention and an engagement member of a beverage preparation machine before engaging with each other.

FIG. 7b is a sectional side view in direction D-D of FIG. 2 of a preferred embodiment of the sealing member according to the invention and an engagement member of a beverage preparation machine after engaging with each other.

FIG. 8a is a sectional side view in direction C-C of FIG. 2 of a preferred embodiment of the sealing member according to the invention and an engagement member of a beverage preparation machine before engaging with each other.

FIG. 8b is a sectional side view in direction C-C of FIG. 2 of a preferred embodiment of the sealing member according to the invention and an engagement member of a beverage preparation machine after engaging with each other.

### DETAILED DESCRIPTION OF THE FIGURES

In the following detailed description, reference is made to the accompanying drawings, which form a part hereof.

In the drawings, similar symbols and references typically identify similar components, unless context dictates otherwise.

The illustrative embodiments described in the detailed description and drawings are not meant to be limiting. Other embodiments may be utilized, and other changes may be made, without departing from the scope of the claimed subject matter presented here.

It will be readily understood that the aspects of the present disclosure, as generally described herein, and illustrated in the figures, may be arranged, substituted, combined, and designed in a wide variety of different configurations, all of which are explicitly contemplated and make part of this disclosure.

As used in this specification, the words “comprises”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

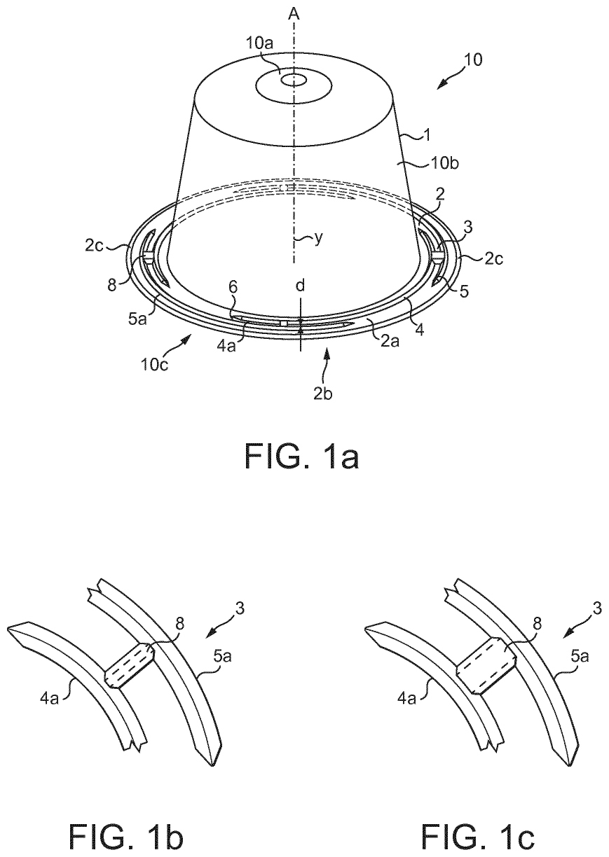

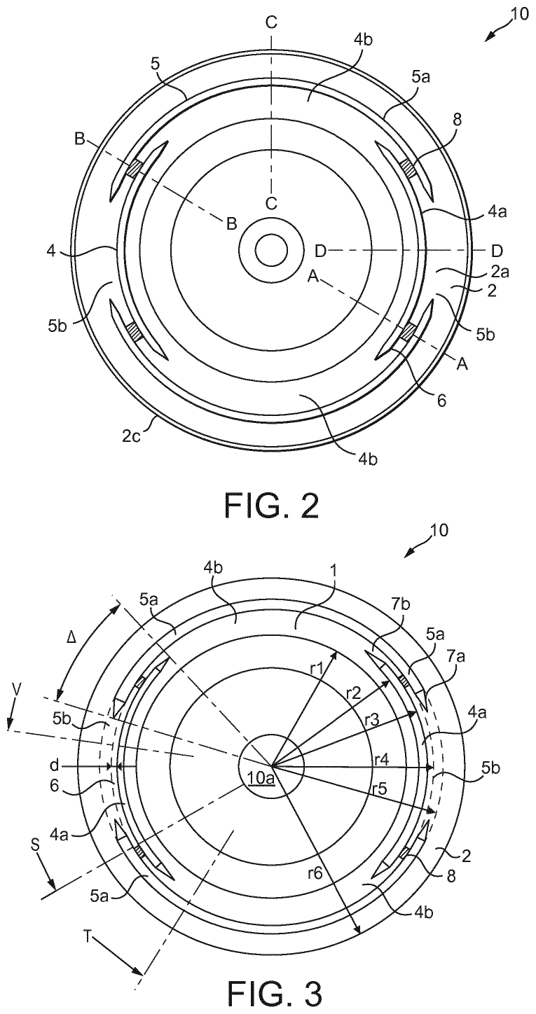

FIG. 1a and FIG. 2 presenting a perspective side view and a top view of a capsule will be described jointly as related to a preferred embodiment of the invention.

Additionally, FIGS. 1b and 1c presenting different bridging element that could be used in a capsule according to the invention will be described in connection with FIG. 1a and FIG. 2.

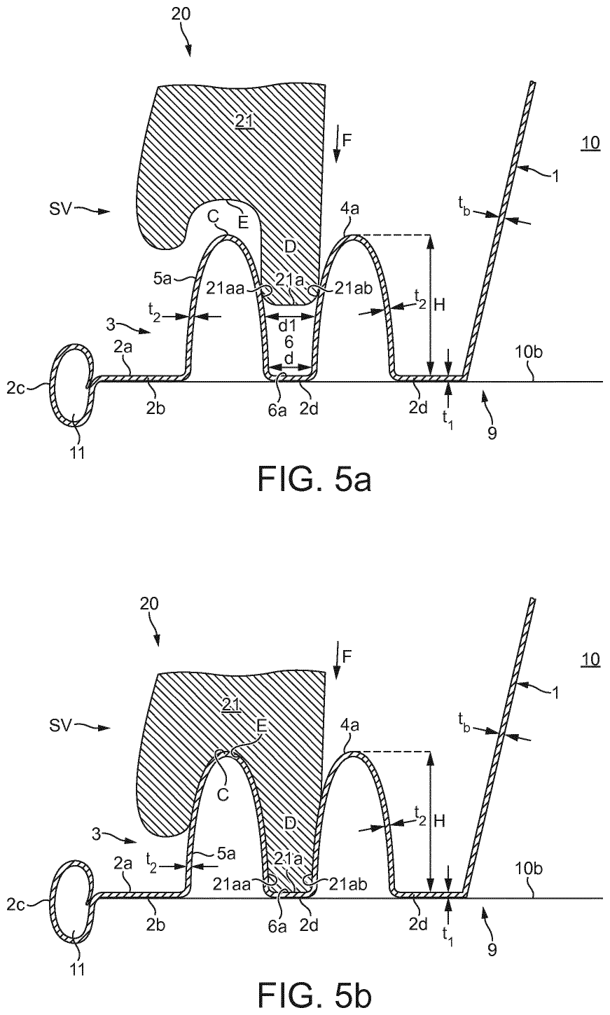

FIG. 1a and FIG. 2 relate to a preferred embodiment of a capsule 10 according to the invention. The capsule 10 comprises a cup-shaped base body 1. The base body 1 comprises a closed end 10a, a sidewall 10b forming the external surface of the base body 1 and an open end 10c. The closed end 10a may serve as an injection face during a beverage preparation process, which may be opened by a dedicated injection member of a beverage preparation machine 20 (presented in FIG. 5a and followings).

The capsule 10 further comprises a flange-like rim 2 which is preferably arranged at the open end 10c of the capsule 10. The flange-like rim 2 may extend radially outwardly from lateral sidewalls 10b of the cup-shaped base body 1. The flange-like rim 2 is preferably arranged transversally to a rotational axis Y of the capsule 10 (rotational axis Y also corresponds to the longitudinal axis A of the capsule 10).

The flange-like rim 2 presents at least one upper annular surface 2a, said surface being directed towards the capsule base body 1 thus facing away from the open end 10c of the capsule, at least one lower annular surface 2b, which surface 2b is directed away from the capsule base body 1 and a curled outer edge 2c at its outer periphery (extremity of the flange-like rim 2 opposite the base body 1).

In the shown embodiment, the capsule is preferably made of aluminum.

At the open end 10b of the capsule base body 1 a closing membrane 9 may be arranged. The closing membrane 9 is preferably connected to the flange-like rim 2 (see for example FIG. 5a). The closing membrane 9 is preferably connected to at least one lower annular surface 2b of the flange-like rim 2, which surface 2b is directed away from the capsule base body 1.

Alternatively, the closing membrane 9 may be connected to the base body 1 or to both the base body 1 and the flange-like rim 2.

The closing membrane 9 is preferably an aluminum foil sealed to the flange-like rim 2.

The cup-shaped base body 1 preferably encloses beverage ingredients suitably for preparing a liquid comestible upon interaction with liquid injected into the capsule 10. The ingredients are preferably enclosed by the cup-shaped base body 1 and the closing membrane 9. The beverage ingredients may be roasted ground coffee or other kinds of ingredients as previously described.

For the preparation of a beverage, the capsule 10 is inserted into the dedicated beverage preparation machine 20 (part of which is presented in FIGS. 5a to 8b). During the extraction process, an engagement member 21 (presented in FIGS. 5a to 8b) of the beverage preparation machine 20 is engaged with the capsule 10: When the capsule 10 is placed into the beverage preparation machine 20, the engagement member 21 is lowered onto the capsule 10 by means of a dedicated closing force F.

The engagement member 21 comprises a sealing profile presenting at least one sealing surface 21a (presented in FIGS. 5a to 8b) coming into contact with the capsule 10.

A radial length L of the sealing surface 21a is defined. The radial length L of the sealing is preferably between 0.5 to 2.0 mm.

Going in more detail, the flange-like rim 2 comprises an integrally formed sealing member 3 that is arranged at the upper annular surface 2a of the flange-like rim.

As mentioned, the flange-like rim 2 comprises an integrally formed sealing member 3 which is arranged at an upper annular surface 2a of the flange-like rim. The annular surface 2a is arranged opposite to the surface 2b to which the closing membrane 9 is preferably connected. The annular surface 2a is thus facing away from the open end 10b of the capsule.

The sealing member 3 comprises an inner and an outer series of arc-shaped protrusions 4,5, which are concentrically arranged on the surface 2a of the flange-like rim 2. The inner and outer series 4,5 of arc-shaped protrusion are integrally formed with the flange-like rim 2. This means that they are formed of same material as the flange-like rim and from the flange-like rim such as (and are not add-on parts) to protrude from the surface 2a.

The inner and an outer series of arc-shaped protrusions 4,5 are arranged to form an annular space 6 there-between for receiving a sealing surface 21a of a capsule engagement member 21 of the beverage preparation machine 20 (see for example FIG. 5a). Therefore, a radial distance d between the inner and outer series 4,5, is preferably chosen such as the protrusions suitably interact in sealing engagement with the dedicated sealing surface 21a of the engagement member 21. More particularly, in the overlap region (FIG. 5a, 5b for example), the dedicated sealing surface actually splits into a sealing surface portion 21aa which engages the protrusions 4b of the outer series and a sealing surface portion 21ab which engages the protrusions 4a of the inner series. The radial distance d is preferably between 0.6 to 1.2 mm, more preferably between 0.8 and 1.0 mm. The annular space 6 between the inner and outer series 4,5 is preferably void of any protrusion. The annular space 6 thus preferably comprises an essentially flat bottom surface 2d which interconnects adjacent arc-shaped protrusions of the inner and outer series 4,5.

The sealing member 3 further comprises at least one bridging element 8. The bringing elements 8 are located between the arc-shaped protrusions 4a,5a of the inner and outer series 4,5 and are locally connecting them.

In more detail, in the overlapping area of the inner and outer series of arc-shaped protrusions 4,5, and in between the inner and outer series 4,5 of arc-shaped protrusions 4a,5a, there is at least one bridging element disposed transversally to the arc-shaped protrusions 4a,5a.

Hence, the bridging elements 8 are positioned transversally between the arc-shaped protrusions 4a,5a of the inner and outer series 4,5 and are thereby closing the annular space 6 between the inner and outer series of arc-shaped protrusions 4,5.

FIGS. 1b and 1c are presenting bridging elements 8 that may be used in the capsule 10 of FIG. 1a.

In FIG. 1b, the bridging element 8 extends transversally and perpendicularly between the arc-shaped protrusions 4a,5a and has a small lateral extension. The lateral extension is about 0.2 to 1 mm.

In FIG. 1c the bridging element 8 presents a lateral extension that is larger, about 1.5 to 3 mm.

The transversal extension of the bridging elements 8 corresponds to the radial distance d between the inner and outer series of arc-shaped protrusions 4,5 and thus relates to the radial extension of the annular space 6.

In the proposed embodiment presented in the figures, the bridging elements 8 are extending radially (transversally and according to the radius of capsule). However, other configuration of the bridging elements may be envisaged. For example, the bridging elements may connect arc shaped protrusions 4a,5a of the inner and outer series in an oblique way. The extension of the bridging elements will then be higher that the radial distance d previously defined.

As presented, the bridging elements 8 are integral with the arc-shaped protrusions 4a,5a of the inner and outer series 4,5.

The key function of the bridging elements 8 is to stop possible side flow that could happen in case the engagement member 21 would not enter down to the bottom of the annular space 6 between the inner and outer series 4,5 of arc shaped protrusions 4a, 5a. The height of the bridging elements 8 should be enough to create tightness with the engagement member 21 of the beverage preparation machine, but it should not be too high, thus preventing the engagement member to enter completely in between the inner and outer series 4,5 arc shaped protrusions 4a, 5a. The bridging elements 8 may be deformed by the engagement member 21 when said engagement member 21 is engaging in the annular space 6 between the inner and outer series 4,5 of arc shaped protrusions 4a, 5a.

For example, the bridging elements 8 may have a height, measured from the surface 2a of the flange-like rim 2, between 0.1 and 0.5 mm.

The cup-shaped base body 1, the flange-like rim 2 and the sealing member 3 are integrally formed, i.e. by one single piece made from the same material. Accordingly, the cup-shaped base body 1, the flange-like rim 2 and the sealing member 3 can be manufactured from the same material by a forming process. In particular, the base body 1, the flange-like rim 2 and the integrally formed sealing member 3 can be formed in a deep-drawing process. The deep drawing process may require more than one deep drawing step to properly form from a flat piece of material the body of the capsule and the sealing member.

The base body 1, the flange-like rim 2 and the sealing member 3 are formed of one piece made of metal, preferably of aluminum, most preferably an aluminum alloy.

The inner and an outer series of arc-shaped protrusions 4,5 and the bridging elements 8 are preferably arranged on the surface 2a distant from an outer circumferential edge or outer end 2c of the flange-like rim 2. The inner and outer series 4,5 are further arranged distant from the cup-shaped base body 1 of the capsule 1. The inner and outer series of arc-shaped protrusions 4,5, is preferably arranged at an annular portion of the surface 2a of the flange-like rim 2 which is nearer to the cup-shaped body 1 than to the outer end 2c. The relative position of the inner and outer series of arc-shaped protrusions on the flange-like rim naturally depends on the matching position of the sealing surfaces determined by the dimensions of the engaging member.

The bridging elements 8 are arranged transversally between the inner and outer series of arc-shaped protrusions 4, 5.

The inner and outer series of arc-shaped protrusions 4,5 each comprise individual arc-shaped protrusions 4a,5a arranged at a predefined radius about a rotational axis Y of the capsule 10. The inner and outer series of the arc-shaped protrusions 4,5 each preferably comprise at least two, more preferably at least three, four, five or six arc-shaped protrusions 4a,5a. The respective arc-shaped protrusions 4a,5a of the inner and outer series 4,5 are preferably continuous protrusions with gaps 4b,5b formed there-between. Clearly, the length of each arc-shaped protrusion 4a, 5a along the circumference will depend on their number and the higher the number, the short the length.

As mentioned, the bridging elements 8 are positioned proximate to the extremities of the respective arc-shaped protrusions 4a,5a in the overlapping portions. The number of bridging elements 8 then depends on the number of arc-shaped protrusions and overlapping portions.

The respective arc-shaped protrusions 4a,5a of the inner and outer series 4,5 are arranged such as to overlap in side view of the capsule. The respective arc-shaped protrusions 5a of the outer series 5 thus overlap with circumferentially extending gaps 4b formed between the respective arc-shaped protrusions 4a of the inner series 4 in side view of the capsule and vice versa. The overlap between the respective arc-shaped protrusions 4a,5a preferably equals at least 20 to 25%, more preferably 30 to 35% of an arc length L of the respective overlapping protrusions 4a,5a. The respective arc-shaped protrusions 4a,5a of the inner and outer series 4,5 are thus arranged at different angles along the 360° circumference of the flange-like rim 2 when seen in top view.

The respective arc-shaped protrusions 4a,5a of the inner and outer series 4,5 may be arranged circumferentially at equidistance to each other about the circumference of the base-body such as to form constant circumferentially extending gaps 4b,5b between the respective protrusions 4a,5a in the respective series 4,5.

Hence, the bridging elements 8 are located near the respective circumferentially extending gaps 4b,5b.

FIG. 3 relates to a schematic top view onto a capsule 10 according to the invention in which the respective radii of the capsule 10 are indicated. As shown in FIG. 3, the capsule base body 1 and the flange-like rim 2 merge at a circumferential edge indicated as r1 and which radius preferably lies between 12 and 18 mm, and most preferably is 15 mm. The outer radius r6 of the flange-like rim 2 at the outer end 2c preferably lies between 18 and 20 mm, and most preferably is 18.5 mm.

The difference between r2 and r3 corresponds to a radial extension of the arc-shaped protrusions 4a and the respective intermediate gaps 4b of the inner series of protrusions 4 and preferably lies between 0.3 and 1.3 mm, more preferably between 0.5 and 1.0 mm.

The difference between r4 and r5 corresponds to a radial extension of the arc-shaped protrusions 5a and the respective intermediate gaps 5b of the outer series of protrusions 5 and preferably lies between 0.3 and 1.3 mm, more preferably between 0.5 and 1.0 mm.

The difference between r3 and r4 corresponds to a radial extension respectively radial distance d of the arc-shaped protrusions 4a,5a as indicated above. A particularly preferred value for the radial distance d is between 0.7 and 1.1 mm, and most preferably is 0.9 mm.

The bridging elements 8 are extending radially between r3 and r4 in the annular space 6 created between the inner and the outer series of arc-shaped protrusions 4,5.

The overlap angular length A between the respective arc-shaped protrusions is between 5° and 85°, preferably between 10° and 70°, most preferably between 20° and 60°.

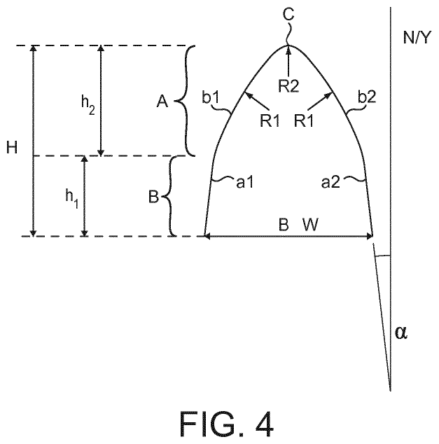

FIG. 4 relates to a cross section side view of an exemplary embodiment of an arc-shaped protrusion 4a,5a. The arc-shaped protrusions 4a,5a preferably comprise essentially the same dimensions in sectional side view. However, the arc-shaped protrusions 4a, 5a could also have different dimensions in sectional side view.

The respective protrusions 4a,5a preferably comprise a lower base portion B with two opposing linear wall sections b1 and b2 and an upper portion A with two opposing rounded wall sections a1 and a2. The two opposing rounded wall sections a1 and a2 of the upper portion A are preferably joined by a rounded tip portion C.

The two opposing linear wall sections b1,b2 are preferably arranged to approach towards the upper portion A of the respective protrusions 4a,5a. The two opposing linear wall sections b1,b2 are preferably arranged at an angle α of inclination of between 3 to 12°, more preferably of between 5 to 10° with respect to the normal N of the flange-like rim 2 and/or with respect to a rotational axis Y of the capsule 10.

The two opposing rounded wall sections a1,a2 of the upper portion A preferably comprise a radius R1 of between 0.5 to 5.5, more preferably between 1 and 5 mm. The rounded tip portion C preferably comprise a radius R2 of between 0.2 and 2.3 mm, more preferably between 0.5 and 2 mm.

A base width BW of the respective protrusions 4a,5a preferably lies between 0.3 and 1.3 mm, more preferably between 0.5 and 1.0 mm. The height H preferably lies between 0.8 and 1.7 mm, more preferably between 1 and 1.5 mm.

The base portion B preferably extends to a height h1 of between between ⅓ to ½ of overall height H. Correspondingly, upper portion A may extend to a height h2 of between ⅔ to ½ of overall height H.

The projections 4a, 5a may comprise free ends 7a, 7b of progressively reducing dimensions to ensure a smoother transition with the surface 2a of the flange-like rim. The width r3-r2, r5-r4 and height H at these free ends 7a, 7b preferably diminish progressively towards circumferentially extending gaps 4b, 5b. In particular, the shape of these ends 7a, 7b may be slightly triangular or rounded when viewed from the top in direction of the flange-like rim as illustrated in FIG. 3. As a result, the forming of the projections is facilitated with lower risk of cracks or wrinkles.

FIGS. 5a and 5b are sectional side views according to direction B-B (FIG. 2) of a preferred embodiment of the sealing member 3 of the capsule 10 and an engagement member 21 of a beverage preparation machine 20 respectively before and after engaging with each other.

As shown in FIG. 5a, and in addition to the previous elements already described, the respective protrusions 4a,5a of the sealing member 3 are preferably hollow. Accordingly, the protrusions 4a,5a are not filled with material of the flange-like rim 2, but are formed by a contour of wall thickness t2. The respective protrusions 4a,5a thus preferably form a hollow body that is open to the lower surface 2b of the flange-like rim 2.

Due to the drawing process, the wall thickness t1 of the flange-like rim 2 may generally be slightly larger than the wall thickness t2 of the protrusions 4a,5a for the same reason, the wall thickness t1, t2 may generally be larger than the wall thickness tb of the base body 2 of the capsule.

The engagement member 21 of the dedicated beverage preparation machine 20 is preferably an essentially hollow bell-shaped engagement member 21 for receiving the capsule base body 1 therein. When the capsule 10 is placed into the beverage preparation machine 20, the engagement member 21 will be lowered onto the capsule 10 by means of a dedicated closing force F as indicated in FIG. 5a. The sealing surface 21a of the engagement member 21 may be an annular lower surface with rounded inner and outer circumferential edges. The front surface (or sealing surface) 21a comprises a radial thickness D which preferably lies between 0.8 and 1.2, more preferably between 0.9 and 1.1 mm.

The annular space 6 between the protrusions 4a,5a of the inner and outer series 4,5 of the sealing member 3 is designed for receiving the sealing surface 21a of the capsule engagement member 21 of the beverage preparation machine 20. The annular space 6 comprises a preferably flat annular bottom surface 6a which interconnects the neighboring protrusions 4a,5a. The annular bottom surface 6a extends to a radial distance respectively thickness d as described above. The distance d is preferably chosen such as to be equal to or slightly smaller than an annular radial thickness D of the sealing surface 21a of the engagement member 21. In a preferred embodiment, thickness d is chosen to be between 0.1 and 0.5, more preferably between 0.2 to 0.3 mm smaller than the annular radial thickness D of the sealing surface 21a.

The annular space 6 preferably widens from the bottom surface 6a towards the tip portions C of the neighboring protrusions 4a,5a. Thereby, the respective upper ends of the base portions B of neighboring protrusions 4a,5a are preferably distanced by a radial distance dl that is larger than the distance d at the bottom surface 6a. The distance dl is preferably chosen to be 0.2 to 0.3 mm larger than the radial thickness D of the sealing surface 21a of the engagement member 21.

When the engagement member 21 is lowered from the position shown in FIG. 5a onto the sealing member 3 by closing force F, the annular sealing surface 21a will engage in the annular space 6, thereby providing a fluid tight engagement between the sealing surface 21a and the neighboring arc-shaped protrusions 4a,5a of the sealing member 3.

In the circumferentially overlapping regions of the protrusions 4a, 5b (FIGS. 5a and 5b), the engagement of the sealing surface 21 may be completed both by the engagement of the outer sealing surface portion 21aa with the wall of the protrusions 5a of the outer series and/or by the engagement of the inner sealing surface portion 21ab with the wall of the protrusions 4a of the inner series. Additionally, the rounded tip portion C may be engaged by a correspondingly formed annular receiving groove E of the engagement member 21. Accordingly, an effective sealing engagement between the sealing member 3 and the engagement member 21 of the beverage preparation machine is obtained.

This is clearly visible in FIG. 5b in which the engagement member 21 fully engages with the inner and outer series 4,5 of arc-shaped protrusions 4a,5a. Indeed, the front surface 21a engage with an annular bottom surface 6a of the annular space 6 which interconnects the neighboring protrusions 4a,5a.

Additionally, the closing membrane 9 is preferably sealed on the annular bottom surfaces 2d and the outer annular surface 2b. Preferably, the annular bottom surface 2d between the inner and outer series 4,5 is not elevated or lowered relative to the outer annular surface 2b and/or the inner annular bottom surface 2d. preferably, the annular bottom surfaces 2d and the outer annular surface 2b are preferably substantially aligned.

As shown in FIGS. 5a and 5b, the closing membrane 9 is connected to an annular outer portion of the surface 2b of the flange-like rim. The closing membrane 9 may additionally be connected to intermediate annular surfaces 2d arranged between the outer annular surface 2b and the capsule base body 1. The closing membrane 9 is preferably an aluminum foil sealed to the flange-like rim 2.

At an outer peripheral edge 2c, the flange-like rim 2 may comprise a rollover edge 11 known in the present technical field.

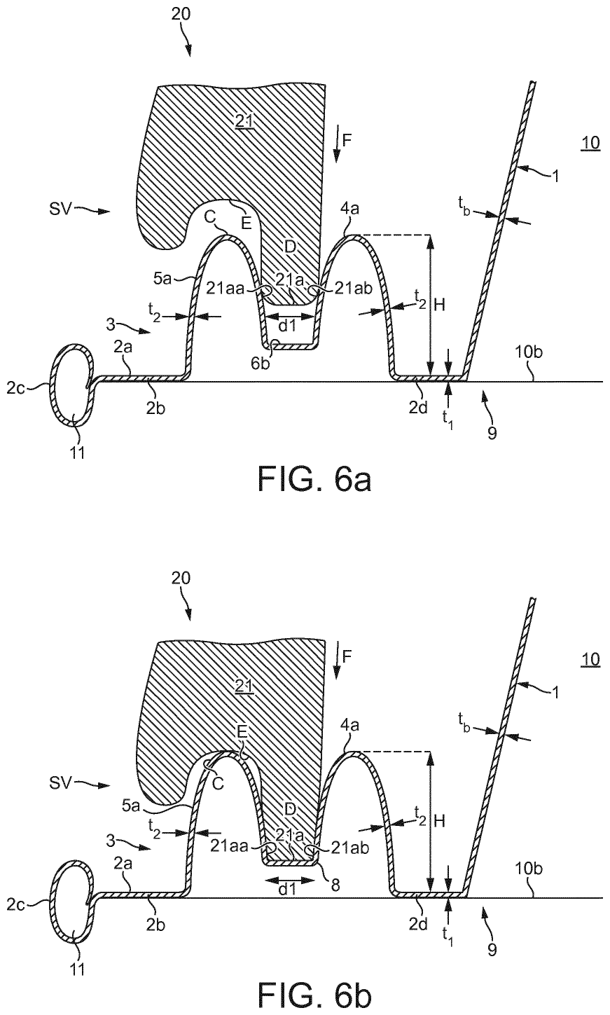

FIG. 6a and FIG. 6b are sectional side views according to direction A-A of FIG. 2 of a preferred embodiment of the sealing member 3 of the capsule 10 and an engagement member 21 of a beverage preparation machine 20 respectively before and after engaging with each other.

The cross sections presented in FIGS. 6a and 6b are cross sections in which one of the bridging elements 8 extends between and connects protrusions 4a,5a.

The bridging element 8 presented in FIGS. 6a and 6b, extends between the protrusions 4a,5a of the inner and outer series 4,5 of the sealing member 3, and is designed for receiving the sealing surface 21a of the capsule engagement member 21 of the beverage preparation machine 20. The bridging element 8 comprises on its upper surface a preferably flat annular bottom surface 6b which interconnects the neighboring protrusions 4a,5a. The bridging element 8 extends to a radial distance dl as described above. The distance dl is preferably chosen such as to be equal to or slightly smaller than an annular radial thickness D of the sealing surface 21a of the engagement member 21. In a preferred embodiment, thickness dl is chosen to be between 0.1 and 0.5, more preferably between 0.2 to 0.3 mm smaller than the annular radial thickness D of the sealing surface 21a.

When the engagement member 21 is lowered from the position shown in FIG. 6a onto the sealing member 3 by closing force F, the annular sealing surface 21a will engage in the annular space 6 and will contact the bridging element 8. During engagement, the sealing surface 21 may deform the bridging element 8, thereby providing a fluid tight engagement between the sealing surface 21a and the capsule.

Additionally, the sealing surface 21a may engage with the neighboring arc-shaped protrusions 4a,5a of the sealing member 3 thereby provide.

In other words, the difference in diameter between the inner and outer series of arc-shaped protrusions 4,5 is such that the engagement member 21 of the coffee preparation machine 20 is intended to fit in the annular space 6 between the inner and outer series of arc-shaped protrusions 4,5 and to compress the bridging elements 8 positioned there between.

The combination of the interaction between engagement member 21 and the inner and outer series of arc-shaped protrusions 4,5, due to their slightly overlapping diameters, and of the engagement between engagement member 21 and bridging elements 8, by compression of the bridging elements 8 by the sealing surface 21a, generates the required tightness between the capsule and the enclosing member of the coffee machine needed for beverage extraction.

In detail, the engagement of the engagement member 21 with the side walls in the overlapping area of the inner and outer series of arc-shaped protrusions 4,5 will produce, mainly, a radial tightness between the capsule 10 and engagement member 21 and the engagement of the engagement member 21 with the bridging elements 8 between the arc-shaped protrusions 4a,5a will produce, mainly, tightness between capsule 10 and engagement member 21 for the potential water flowing in circumferential direction between the arc-shaped protrusions 4a,5a and the underneath sealing surface 21a of the engagement member 21.

The engagement between the sealing surface 21a and the bridging element 8 allow improving the performances, in terms of tightness, of the tightness generated by the arc-shaped protrusions 4a,5a alone.

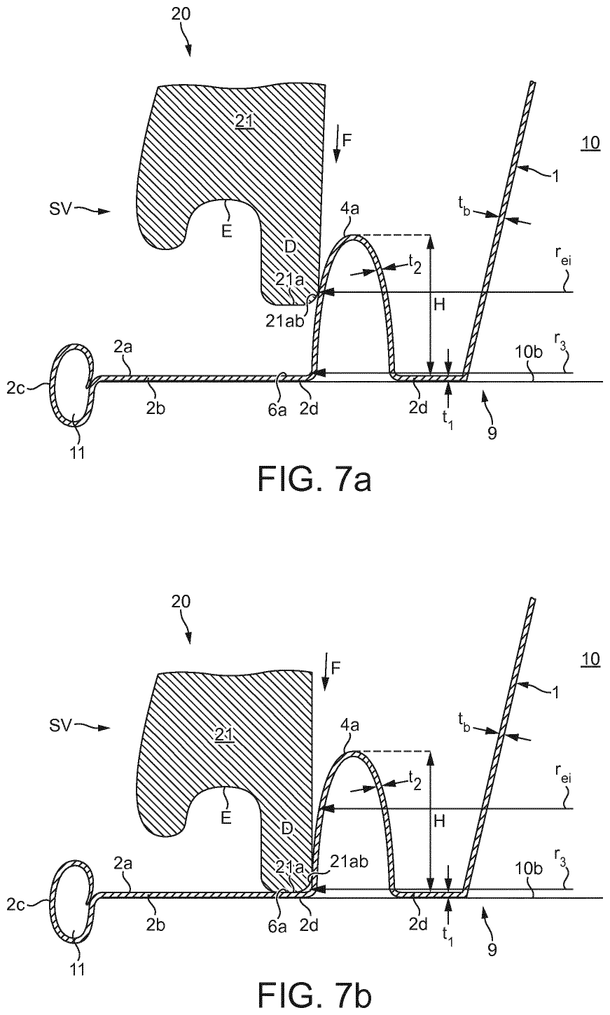

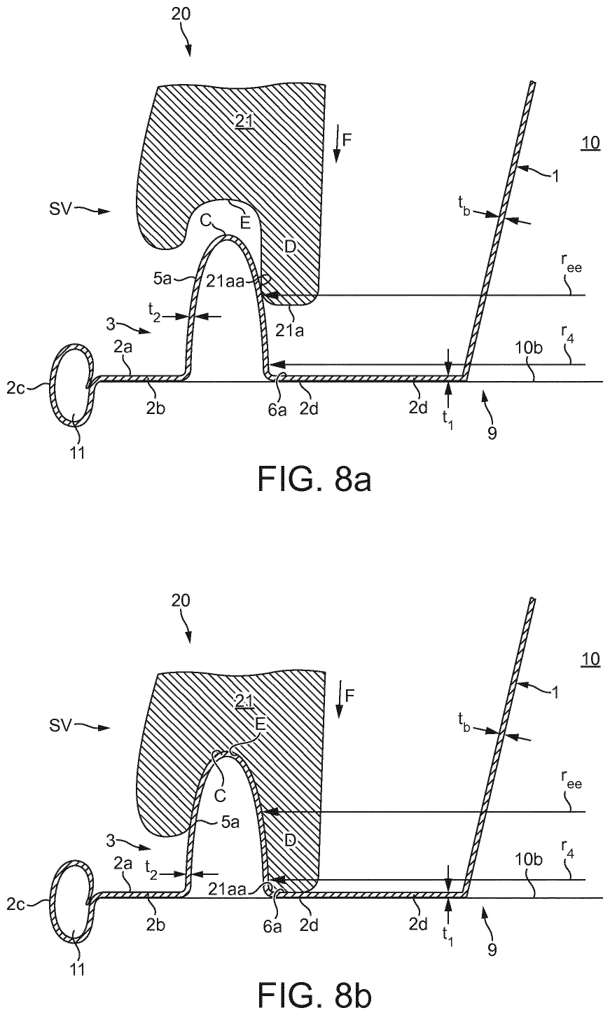

Reference is now made to FIGS. 7a to 8b.

FIGS. 7a and 7b are sectional side views in direction D-D of FIG. 2 of a preferred embodiment of the sealing member according to the invention and an engagement member of a beverage preparation machine respectively before and after engaging with each other.

FIGS. 8a and 8b are sectional side views in direction C-C of FIG. 2 of a preferred embodiment of the sealing member according to the invention and an engagement member of a beverage preparation machine, respectively before and after engaging with each other. These cross sections are outside the circumferentially overlapping regions of the protrusions.

As illustrated in these figures that are cross sections outside the circumferentially overlapping regions of the protrusions, the sealing engagement of the sealing surface 21a of the engagement member 21 may be limited to one of the sealing surface portions 21ab or 21aa respectively with the projections 4a of the inner series (FIG. 7a and 7b) or the projections 5a of the outer series (FIGS. 8a and 8b) respectively.

In the cross sections of FIGS. 7a and 7b, the engagement member 21 will only interact with the inner series of arc-shaped protrusions 4, and especially with sealing surface portion 21aa.

In the cross sections of FIGS. 8a and 8b, the engagement member 21 will only interact with the outer series of arc-shaped protrusions 5, and especially with sealing surface portion 21aa.

As the engagement member 21 is moved towards the flange-like rim 2 by pressure effect during closing and/or extraction, the sealing surface portions 21aa, 21ab may respectively deform the arc-shaped protrusions 4, 5 according to the cross section that is considered and increase the contact surface area with the protrusions accordingly.

In particular, as shown in FIGS. 7a and 7b, the radius rei of the position of the sealing surface portion 21ab of the engaging member 21 suitable to engage the projections 4a of the inner series is preferably chosen smaller than the outer radius r3 of protrusions 4. As shown in FIGS. 8a and 8b, the radius ree of the position of the sealing surface portion 21aa of the engaging member 21 suitable to engage the projections 5a of the inner series is preferably chosen larger than the radius r4 of the radial extension of the arc-shaped protrusions 5a. As a result, a sealing pressure is exerted about the whole circumference of the sealing surface 21a of the engagement member by the sealing member 3 thereby ensuring a sealing continuity.

1. A capsule designed for preparing a beverage upon injection of liquid into the capsule by a beverage preparation machine,
the capsule comprising a cup-shaped base body for holding beverage preparation ingredients and a flange-like rim with a sealing member comprising an inner and an outer series of arc-shaped protrusions,
wherein the base-body, the flange-like rim and the sealing member are made integrally from metallic material,
wherein the inner and outer series of the sealing member are concentrically arranged on a surface of the flange-like rim such as to form an annular space there-between for receiving a sealing surface of a capsule engagement member of the beverage preparation machine,
wherein the respective arc-shaped protrusions of the inner and outer series are continuous protrusions with circumferentially extending gaps formed there-between,
wherein the respective arc-shaped protrusions of the inner and outer series are arranged such as to circumferentially overlap outside the circumferentially extending gaps of the inner and outer series in side view of the capsule, and
wherein the arc-shaped protrusions of the inner and outer series are locally connected together by at least one bridging element positioned proximate to each circumferentially extending gaps of the inner and outer series.

2. The capsule of claim 1,
wherein the inner and outer series of the arc-shaped protrusions each comprise at least two arc-shaped protrusions.

3. The capsule of claim 1,
wherein the at least one bridge element extends transversally between the arc-shaped protrusions of the inner and outer series and closes the annular space between the inner and outer series of arc-shaped protrusions.

4. The capsule of claim 1,
wherein the at least one bridge element is integral with the arc-shaped protrusions of the inner and outer series.

5. The capsule of claim 1,
wherein the overlap between the respective arc-shaped protrusions equals at least 20 to 25% of an arc length (L) of the respective overlapping protrusions.

6. The capsule of claim 1,
wherein the overlap angular length between the respective arc-shaped protrusions is between 5° and 85°.

7. The capsule of claim 1,
wherein the respective arc-shaped protrusions of the inner and outer series are arranged equidistant to each other about the circumference of the base-body such as to form constant circumferentially extending gaps between the respective protrusions.

8. The capsule of claim 1,
wherein the inner and outer series of arc-shaped protrusions are arranged distant from the cup-shaped base body and an outer periphery of the flange-like rim.

9. The capsule of claim 1,
wherein the inner and outer series of arc-shaped protrusions are arranged at a radial distance of between 0.6 to 1.2 mm.

10. The capsule of claim 1,
wherein the capsule body, the flange-like rim and the sealing member are produced by deep drawing an initially flat metal sheet.

11. The capsule of claim 1,
wherein the capsule is made from aluminum.

12. The capsule of claim 1,
wherein the capsule further comprises a closing membrane connected to the base body and/or the flange-like rim of the capsule.

13. The capsule according to claim 12,
wherein the closing membrane is connected to a surface of the flange-like rim opposite to the surface at which the inner and outer series of arc-shaped protrusions are arranged.

14. The capsule according to claim 12,
wherein the closing membrane is an aluminum foil sealed to the flange-like rim and/or the base body.

15. A system comprising a capsule designed for preparing a beverage upon injection of liquid into the capsule by a beverage preparation machine, the capsule comprising a cup-shaped base body for holding beverage preparation ingredients and a flange-like rim with a sealing member comprising an inner and an outer series of arc-shaped protrusions, wherein the base-body, the flange-like rim and the sealing member are made integrally from metallic material, wherein the inner and outer series of the sealing member are concentrically arranged on a surface of the flange-like rim such as to form an annular space there-between for receiving a sealing surface of a capsule engagement member of the beverage preparation machine, wherein the respective arc-shaped protrusions of the inner and outer series are continuous protrusions with circumferentially extending gaps formed there-between, wherein the respective arc-shaped protrusions of the inner and outer series are arranged such as to circumferentially overlap outside the circumferentially extending gaps of the inner and outer series in side view of the capsule, and wherein the arc-shaped protrusions of the inner and outer series are locally connected together by at least one bridging element positioned proximate to each circumferentially extending gaps of the inner and outer series and a beverage preparation machine designed to provide heated and/or pressurized liquid into the capsule for preparing a beverage upon interaction of the liquid with ingredients held within the capsule.

16. A cup-shaped base body of a capsule for holding beverage preparation ingredients and a flange-like rim with a sealing member comprising an inner and an outer series of arc-shaped protrusions,
wherein the base-body, the flange-like rim and the sealing member are made integrally from metallic material,
wherein the inner and outer series of the sealing member are concentrically arranged on a surface of the flange-like rim such as to form an annular space there-between for receiving a sealing surface of a capsule engagement member of the beverage preparation machine,
wherein the respective arc-shaped protrusions of the inner and outer series are continuous protrusions with circumferentially extending gaps formed there-between,
wherein the respective arc-shaped protrusions of the inner and outer series are arranged such as to circumferentially overlap outside the circumferentially extending gaps of the inner and outer series in side view of the capsule, and
wherein the arc-shaped protrusions of the inner and outer series are locally connected together by at least one bridging element positioned proximate to each circumferentially extending gaps of the inner and outer series.
